(19) United States
(12) Patent Application Publication
(10) Pub. No.: US 2026/0155270 A1
(43) Pub. Date: Jun. 4, 2026

(54) AIR PURIFICATION PROCESSING APPARATUS

(71) Applicant: Century Co., Ltd., Cheongdo-gun (KR)

(72) Inventors: Yonghun CHO, Cheonan-si (KR); Kaphyun YOO, Cheonan-si (KR); Jungsu OH, Seoul (KR); Sungmin SUH, Gimpo-si (KR); Juyong JEONG, Paju-si (KR)

(73) Assignee: Century Co., Ltd., Cheongdo-gun (KR)

(21) Appl. No.: 19/401,812

(22) Filed: Nov. 26, 2025

(30) Foreign Application Priority Data
Dec. 4, 2024 (KR) 10-2024-0178619

(51) Int. Cl. G21F 9/02; B01D 53/04; F24F 8/108

(52) U.S. Cl. CPC G21F 9/02; B01D 53/0407; F24F 8/108

(57) ABSTRACT

An embodiment of the present invention relates to an air treatment device, wherein the air treatment device installed in a containment building includes a body, an inlet for guiding the inflow of air into the body, an adsorber supported on the body, a catalyst spaced apart from the adsorber in the body, and an outlet for guiding the discharge of air from the body.

### CROSS-REFERENCE TO RELATED APPLICATIONS

This application claims benefit and priority to Korean Patent Application No. 10-2024-0178619, filed on Dec. 4, 2024, with the Korean Intellectual Property Office, the disclosure of which is incorporated herein in its entirety by reference.

### TECHNICAL FIELD

An embodiment of the present invention relates to an air treatment device, and more particularly, to an air treatment device capable of treating radioactive materials and hydrogen contained in air.

### BACKGROUND

Generally, if radioactive materials leak inside the containment building of a nuclear power plant, a major accident can occur if this radioactive materials leak outside the containment building. Specifically, containment buildings are equipped with emergency response technologies for natural disasters, safety features, and disaster prevention. Additionally, depressurization facilities and exhaust facilities are provided to prevent damage to the containment building.

However, in the case of a containment building, it is necessary to proactively treat such radioactive materials within the containment building rather than treating it outside the containment building. In particular, after the enactment of legislation on serious accidents, the development of devices and facilities that proactively reduce risk factors leading to serious accidents is required.

Additionally, a device capable of treating radioactive materials is needed even in situations where there is a problem with a power or distribution facility system when radioactive materials leak inside the containment building.

### SUMMARY

An embodiment of the present invention provides an air treatment device capable of treating radioactive materials by generating a flow of air without power within a containment building.

According to an embodiment of the present invention, an air treatment device installed in a containment building includes a body, an inlet that guides an inflow of air into the body, an adsorber supported by the body, a catalyst disposed in the body and spaced apart from the adsorber, and an outlet that guides the discharge of air from the body.

Additionally, the adsorber may reduce radioactive materials contained in the air.

Additionally, the catalyst may generate heat upon contact with air.

Additionally, the catalyst may react with hydrogen contained in the air.

Additionally, the adsorber may be disposed relatively closer to the inlet than the outlet.

Additionally, the catalyst may be disposed between the adsorber and the outlet.

In addition, the body may be formed to be long in one direction, and the inlet may be disposed on a lower side and the outlet may be disposed on an upper side.

Additionally, air outside the body can be introduced through the inlet and discharged through the outlet by thermal energy generated by the heat generation of the catalyst.

Additionally, the air treatment device described above may further include a door providing access to at least one of the adsorber and the catalyst.

Additionally, at least a portion of the inlet may be arranged parallel to the longitudinal direction of the body.

Additionally, a filter may be disposed in the inlet.

Additionally, a mesh may be disposed in the outlet.

Additionally, a plurality of inlets may be formed on the body, facing different directions.

Additionally, at least some of the plurality of inlets may guide air to flow into the body in directions that intersect each other.

Alternatively, according to an embodiment of the present invention, an air treatment device installed in a space where radioactive materials may leak includes a body, an inlet positioned at a lower portion of the body to guide the inflow of air into the body, an adsorber that reduces radioactive materials contained in the air introduced into the body, a catalyst that removes hydrogen contained in the air that has passed through the adsorber, and an outlet that guides the discharge of the air that has passed through the catalyst.

Additionally, the catalyst may generate heat to remove hydrogen when it comes into contact with hydrogen contained in the air.

Additionally, the catalyst may provide energy for introducing and moving air into the body.

Additionally, the separation distance between the adsorber and the catalyst in a direction parallel to the longitudinal direction of the body may be arranged to be relatively shorter than the separation distance between the catalyst and the outlet.

According to an embodiment of the present invention, an air treatment device can effectively treat radioactive material and hydrogen by generating a flow of air without power within a containment building.

### BRIEF DESCRIPTION OF THE DRAWINGS

FIG. 1 illustrates a side view of an air treatment device according to one embodiment of the present invention.

FIG. 2 shows a front view of an air treatment device according to one embodiment of the present invention.

FIG. 3 shows a cross-sectional view of an air treatment device according to one embodiment of the present invention.

### DETAILED DESCRIPTION OF THE INVENTION

Hereinafter, an embodiment of the present disclosure will be described in detail with reference to the accompanying drawings so that a person having ordinary skill in the art to which the present disclosure belongs can easily carry out this embodiment. The present disclosure may be implemented in various forms without being limited to the following embodiments.

It is to be noted that the drawings are schematic and not drawn to scale. Relative dimensions and proportions of parts in the drawings may be exaggerated or reduced for the sake of clarity and convenience, and any dimensions are merely illustrative and not restrictive. Further, the same reference numerals are used throughout the drawings to designate the same or similar components.

The embodiment of the present disclosure specifically represents an ideal form of the present disclosure. Thus, various modifications of the diagrams are expected. Therefore, an embodiment is not limited to a specific form as shown in the drawings, and covers, for example, a change in a form by manufacturing.

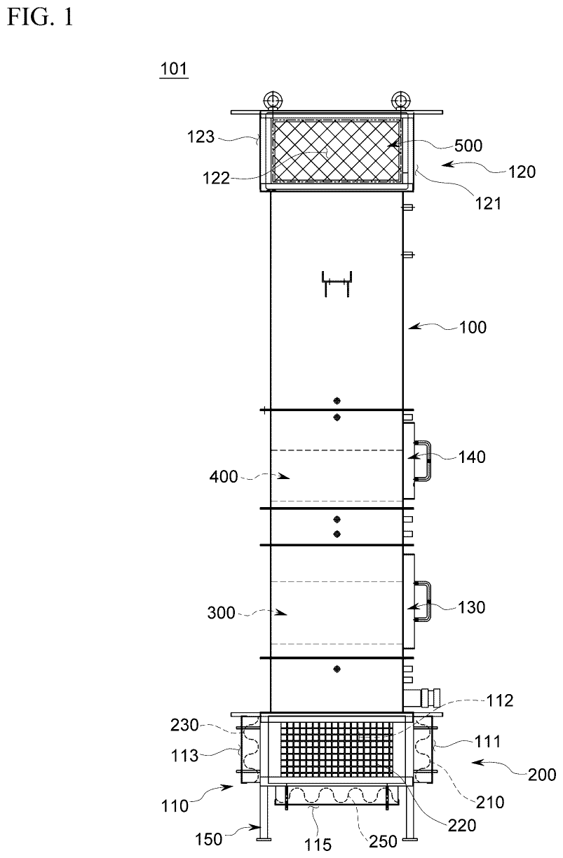

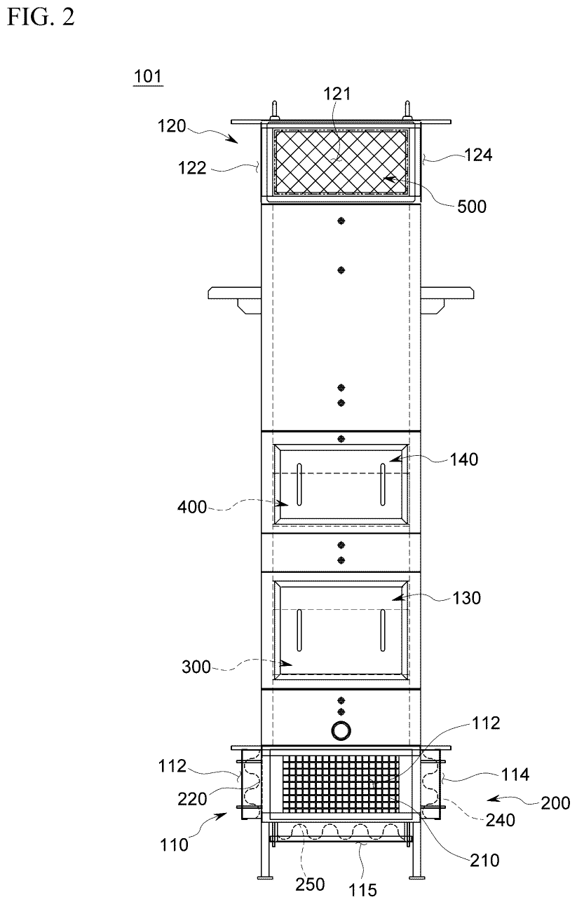

Hereinafter, an air treatment device (101) according to one embodiment of the present invention will be described with reference to FIGS. 1 and 2.

The air treatment device (101) is installed in a containment building. Specifically, the air treatment device (101) is installed inside the containment building of a nuclear power plant and can prevent damage to the containment building by removing radioactive materials when it leaks.

An air treatment device (101) according to one embodiment of the present invention, as shown in FIGS. 1 and 2, includes a body (100), an inlet (110), an adsorber (300), a catalyst (400), and an outlet (120).

The body (100) is formed with a hollow portion inside to allow ambient air to move therethrough. Additionally, the body (100) forms the exterior of the air treatment device (101).

The inlet (110) guides the inflow of air into the body (100). Specifically, the inlet (110) is an area through which air from outside the body (100) passes when it flows into the interior of the body (100). A plurality of inlets (110) may be formed to guide air to flow into the body (100) from various directions.

The adsorber (300) is supported on the body (100). Additionally, the adsorber (300) is installed inside the body (100), and air introduced into the body (100) passes through the adsorber.

The catalyst (400) is supported on the body (100). Additionally, the catalyst (400) is disposed so as to be spaced apart from the adsorber (300). Specifically, the catalyst (400) can be disposed within the body (100) so as to be spaced apart from the adsorber (300). In addition, a flow path is formed inside the catalyst (400) so that air inside the body (100) can pass through.

The outlet (120) guides the discharge of air from the body (100). Specifically, the outlet (120) can be formed so that air introduced into the body (100) is discharged from the body (100). A plurality of outlets (120) may be formed to guide air to be discharged outside the body (100) in various directions.

With such a configuration, the air treatment device (101) according to one embodiment of the present invention can be installed inside a containment building to effectively treat radioactive materials when it leaks, thereby preventing damage to the containment building. In addition, the air treatment device (101) can prevent a large amount of radioactive materials from leaking outside the containment building in the event of a radioactive materials leakage accident inside the nuclear power plant.

Additionally, the adsorber (300) according to one embodiment of the present invention can reduce radioactive materials contained in air.

The adsorber (300) can adsorb radioactive materials contained in the air. Specifically, air containing radioactive material passes through the adsorber (300), and the radioactive material is adsorbed on the adsorber (300), so that the radioactive material contained in the air can be reduced. A flow path can be formed inside the adsorber (300) so that the flow of air is not significantly hindered by the differential pressure between the inlet of the adsorber (300) and the outlet of the adsorber (300) when air passes through it.

The adsorber (300) can be formed of a material capable of adsorbing radioactive materials contained in the air.

Additionally, the catalyst (400) according to one embodiment of the present invention may generate heat when in contact with air.

The catalyst (400) may be formed of a material that undergoes an exothermic reaction when in contact with air and releases thermal energy. Specifically, the catalyst (400) can react with hydrogen contained in the air and generate heat.

For example, the catalyst (400) generates heat when it comes into contact with hydrogen contained in radioactive materials, thereby removing hydrogen from the air that has passed through the catalyst (400). In addition, the catalyst (400) can be coated, filled, or impregnated with a material capable of removing hydrogen and radioactive materials, such as particulate aerosols and gaseous iodine. Therefore, thermal energy can be released by contact between the catalyst (400) and air (hydrogen).

For example, the catalyst (400) may include ion-exchanged alumina.

Additionally, the adsorber (300) according to one embodiment of the present invention may be disposed relatively closer to the inlet (110) than the outlet (120).

Air containing radioactive materials that has passed through the inlet (110) and entered the body (100) passes through the adsorber (300), and the concentration of radioactive materials contained in the air can be reduced.

Additionally, a catalyst (400) according to one embodiment of the present invention may be disposed between the adsorber (300) and the outlet (120).

Air with a reduced concentration of radioactive materials that has passed through the adsorber (300) can pass through the catalyst (400). Specifically, hydrogen contained in air with a reduced concentration of radioactive materials can pass through and come into contact with the catalyst (400). Additionally, the material coated on or impregnated in the catalyst (400) and hydrogen may react to generate heat. Therefore, the air that has passed through the catalyst (400) may be air with an improved hydrogen removal rate due to heat generation.

For example, the separation distance between the adsorber (300) and the catalyst (400) may be arranged to have a relatively smaller value than the separation distance between the catalyst (400) and the outlet (120). That is, air from which hydrogen has been removed, now having thermal energy, can move along the body (100) and be discharged through the outlet (120).

In addition, the inlet (110) of the air treatment device (101) according to one embodiment of the present invention may be disposed on the lower side of the body (100), and the outlet (120) may be disposed on the upper side of the body (100).

The body (100) can be formed to be long in one direction. The inlet (110) can be formed on the lower side of the body (100). The outlet (120) can be formed on the upper side of the body (100).

Accordingly, the thermal energy from the catalyst (400) can cause a convection phenomenon (flow) in the air inside the containment building. Specifically, air having been heated by the catalyst (400) to a relatively higher temperature than the air outside the body (100) is discharged to the outside of the body (100) through the outlet (120), which allows air of a relatively lower temperature outside the body (100) to be drawn into the interior of the body (100). Air with thermal energy can cause the air inside the body (100) and inside the containment building to circulate by convection.

That is, the thermal energy from the contact between the catalyst (400) and hydrogen causes the formation of convection, so that the air treatment device (101) can treat air even in a situation where there is no separate fan or other configuration for sucking outside air into the interior of the body (100), or where there is no distribution facility or power supply device required for its operation.

In addition, even if there is no power to operate a fan due to an unexpected accident inside the containment building, thermal energy generated by the contact between the catalyst (400) and the hydrogen contained in the air can generate air flow when radioactive materials leak. In addition, since there is no need for space to install the above-described fan, etc. inside the body (100), the air treatment device (101) according to one embodiment of the present invention can be made compact.

In other words, due to the relatively large separation distance between the catalyst (400) and the outlet (120), a chimney effect can be generated in which air having thermal energy moves toward the outlet (120) along the longitudinal direction of the body (100), causing air of a relatively low temperature to flow into the inlet (110) formed on the lower side of the body (100).

Additionally, the air treatment device (101) according to one embodiment of the present invention may further include doors (130, 140).

The doors (130, 140) can be supported on the body (100). Additionally, the doors (130, 140) may allow an operator to access at least one of the adsorber (300) and the catalyst (400). Specifically, the doors (130, 140) can open an area of the body (100) for the installation and replacement of either the adsorber (300) or the catalyst (400).

The doors (130, 140) may include a first door (130) that opens when installing and replacing the adsorber (300) and a second door (140) that opens when installing and replacing the catalyst (400). The first and second doors (130, 140) can be detachably supported on the body (100).

Additionally, an unillustrated airtight member may be disposed between the first and second doors (130, 140) and the body (100).

Additionally, a plurality of inlets (110) according to one embodiment of the present invention may be formed to face different directions.

The inlet (110) may include a first inlet (111), a second inlet (112), a third inlet (113), a fourth inlet (114), and a fifth inlet (115).

The body (100) is formed with an approximately “square” cross-section, such that a first inlet (111), a second inlet (112), a third inlet (113), and a fourth inlet (114) can be formed therethrough on different surfaces.

The fifth inlet (115) can be formed to face parallel to the longitudinal direction of the body (100). Specifically, the fifth inlet (115) can be formed to communicate with the floor of the containment building. The lower part of the body (100) can be spaced apart from the floor surface of the containment building by a leg member (150).

That is, air from outside the body (100) can be introduced into the body (100) through the fifth inlet (115) through the space between the floor of the containment building and the body (100), the space having a height corresponding to that of the leg member (150).

A plurality of inlets (110) are formed facing different directions so that air can be effectively introduced into the body (100).

Additionally, a filter (200) may be disposed in the inlet (110) according to one embodiment of the present invention. The filter (200) may include a metal material. The filter (200) can prevent foreign substances contained in the air from entering the interior of the body (100). Additionally, the filter (200) may be formed to include a material that reduces radioactive materials contained in the air.

Accordingly, the filter (200) can reduce the concentration of radioactive materials contained in the air flowing into the body (100) before supplying it.

For example, the filter (200) may also include a first filter (210), a second filter (220), a third filter (230), a fourth filter (240), and a fifth filter (250). Specifically, a plurality of filters may be arranged to correspond to each of a plurality of inlets.

In addition, the air treatment device (101) according to one embodiment of the present invention may further comprise a mesh (500).

A mesh (500) can be disposed in the outlet (120). The mesh (500) may include a grill, metal mesh, etc., through which air can pass. The mesh (500) guides the movement of air passing through the outlet (120) and can prevent large foreign substances from outside the body (100) from entering through the outlet (120).

For example, the outlet (120) may be formed of a first outlet (121), a second outlet (122), a third outlet (123), and a fourth outlet (124) penetrating through different surfaces of a body (100) having an approximately “square” cross-section. In addition, a plurality of meshes (500) can be disposed in each of the outlets.

With such a configuration, the air treatment device (101) according to one embodiment of the present invention can be installed inside a containment building of a nuclear power plant where radioactive materials may leak, and can prevent a large amount of radioactive materials from leaking outside the containment building.

In addition, the air treatment device (101) can effectively reduce or remove radioactive materials contained in the air even without power. Therefore, the air treatment device (101) can prevent the containment building from being damaged and prevent an incident from developing into a major accident.

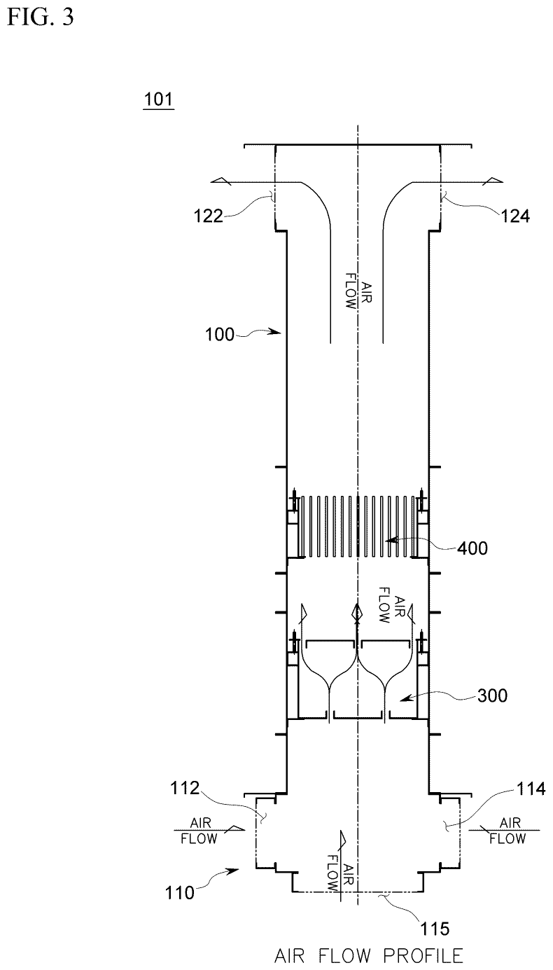

Hereinafter, the operation of an air treatment device (101) according to one embodiment of the present invention will be described with reference to FIGS. 1 to 3.

Air containing radioactive materials is introduced into the body (100) through one or more of a plurality of inlets (110) facing different directions. At this time, air containing radioactive materials passes through the filter (200), after which at least some of the radioactive materials are removed before the air flows into the body (100).

Air containing radioactive materials passes through the adsorber (300). When passing through the adsorber (300), radioactive materials contained in the air are adsorbed by the adsorber (300).

Then, the air containing hydrogen that has passed through the adsorber (300) passes through the catalyst (400). At this time, the material coated on or impregnated in the catalyst (400) and hydrogen undergo an exothermic reaction, generating thermal energy. Additionally, the air that has passed through the catalyst (400) is in a state where a large amount of hydrogen has been removed.

Due to the thermal energy, the inflow of air from outside the body (100) into the interior of the body (100) can be accelerated by the generation of a chimney effect and convection. Therefore, the air treatment device (101) can generate air flow without power.

Air from which a large amount of hydrogen has been removed after passing through the catalyst (400) has thermal energy, passes through the interior of the body (100), and can be discharged through one or more of a plurality of outlets (120) facing different directions.

Accordingly, the air treatment device (101) according to one embodiment of the present invention can preemptively filter and discharge radioactive materials generated inside a containment building, thereby minimizing the occurrence of a dangerous situation in which a large amount of radioactive materials leak.

Although the embodiments of the present invention have been described with reference to the accompanying drawings, those skilled in the art will understand that the present invention can be implemented in other specific forms without changing the technical spirit or essential features thereof.

Therefore, the embodiments described above should be understood as being exemplary and not limiting in all respects, and the scope of the present invention is indicated by the appended claims rather than the foregoing detailed description, and all changes or modifications derived from the meaning and scope of the claims and their equivalent concepts should be interpreted as being included in the scope of the present invention.

### DETAILED DESCRIPTION OF MAIN ELEMENTS

100: Body 101: Air treatment device
110: Inlet 200: Filter
300: Adsorber 400: Catalyst
500: Mesh
120: Outlet 130, 140: Doors

What is claimed is:

1. An air treatment device installed in a containment building, comprising:
a body;
an inlet for guiding the inflow of air into the body;
an adsorber supported by the body;
a catalyst disposed in the body and spaced apart from the adsorber; and
an outlet that guides the discharge of air from the body.

2. The air treatment device of claim 1, wherein the adsorber is configured to reduce radioactive materials contained in the air.

3. The air treatment device of claim 1, wherein the catalyst is configured to generate heat upon contact with air.

4. The air treatment device of claim 3, wherein the catalyst is configured to react with hydrogen contained in the air.

5. The air treatment device of claim 1, wherein the adsorber is disposed relatively closer to the inlet than to the outlet.

6. The air treatment device of claim 5, wherein the catalyst is disposed between the adsorber and the outlet.

7. The air treatment device of claim 3, wherein the body is formed to be long in one direction, the inlet is disposed on a lower side, and the outlet is disposed on an upper side.

8. The air treatment device of claim 7, wherein air outside the body is introduced from the inlet and discharged to the outlet by thermal energy generated by the heat generation of the catalyst.

9. The air treatment device of claim 1, further comprising:
a door providing access to at least one of the adsorber and the catalyst.

10. The air treatment device of claim 1, wherein at least a portion of the inlet is arranged parallel to the longitudinal direction of the body.

11. The air treatment device of claim 1, wherein a filter is disposed in the inlet.

12. The air treatment device of claim 1, wherein a mesh is disposed in the outlet.

13. The air treatment device of claim 10, wherein a plurality of the inlets are formed on the body, facing different directions.

14. The air treatment device of claim 13, wherein at least some of the plurality of inlets guide air to flow into the body in directions that intersect each other.

15. An air treatment device installed in a space where radioactive materials may leak, comprising:
a body;
an inlet positioned at a lower portion of the body to guide the inflow of air into the body;
an adsorber that reduces radioactive materials contained in the air introduced into the body;
a catalyst for removing hydrogen contained in the air that has passed through the adsorber; and
an outlet that guides the discharge of the air that has passed through the catalyst.

16. The air treatment device of claim 15, wherein the catalyst generates heat when in contact with hydrogen contained in the air to remove the hydrogen.

17. The air treatment device of claim 16, wherein the catalyst is configured to provide energy for introducing and moving air into the body.

18. The air treatment device of claim 15, wherein the separation distance between the adsorber and the catalyst in a direction parallel to the longitudinal direction of the body is relatively shorter than the separation distance between the catalyst and the outlet.
